(19) United States
(12) Patent Application Publication
(10) Pub. No.: US 2003/0191957 A1
(43) Pub. Date: Oct. 9, 2003

(54) DISTRIBUTED COMPUTER VIRUS DETECTION AND SCANNING

(76) Inventors: ARI HYPPONEN, ESPOO (FI); MIKKO HYPPONEN, ESPOO (FI); TEEMU SAMULI LEHTONEN, ESPOO (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 09/252,967

(22) Filed: Feb. 19, 1999

(51) Int. Cl. H02H 3/05

(52) U.S. Cl. 713/200

(57) ABSTRACT

A method of detecting viruses in a computer network 1 comprising intercepting data at at least one data transit node 4 of the network 1. The transit node 4 identifies which of the data is of a type capable of containing a virus and transfers the identified data to a virus scanning server 7 over the network 1. The identified data is received at the virus scanning server 7 which scans the data to identify viruses present therein. The server 7 subsequently acts in dependence upon the outcome of the virus scan.

### FIELD OF THE INVENTION

The present invention relates to a method and apparatus for detecting computer viruses and more particularly to the detection of viruses in a computer network environment.

### BACKGROUND TO THE INVENTION

Computer viruses are today a well recognised problem in the computer and software industry and amongst computer users in general. One common type of virus today is the so-called “macro-virus” which infects software macros. More traditional viruses also remain a problem in the computer world, these viruses including those which attach themselves to executable code, e.g. .exe, .com, .bat files.

Whilst early approaches to virus detection relied upon providing an anti-virus program, capable of detecting previously identified viruses or suspect files, in each individual computer, the recent growth in network computing has led to the introduction of gateway based solutions. This involves supplementing, or replacing, the anti-virus programs running on individual computers connected to a network with an anti-virus program running on the or each gateway which connects the network to the outside world, as described for example in U.S. Pat. Nos. 5,623,600 and 5,832,208. Thus, an anti-virus program may be provided at a network Internet server, mail server etc. An antivirus program may also be provided at a database server of the network to screen data transfers to and from a central storage database. The advantage of this centralised approach is that the screening of data need be conducted only when data enters the network and repeated screening at individual client computers is avoided.

In networks having multiple gateways, the approach described above has two major disadvantages. Firstly, the virus scanning operation is typically secondary to the main function of the gateway, e.g. in the case of a mail server the primary function is the routing of mail messages. Performing virus scanning occupies processing power within the gateway, slowing up the overall gateway performance. Secondly, as virus scanning programs generally need to be continuously updated to be effective, e.g. by the incorporation of information relating to newly discovered viruses, the administration of a network having multiple gateway with respective virus scanning programs can be complex and time consuming.

### SUMMARY OF THE PRESENT INVENTION

It is an object of the present invention to overcome or at least mitigate the above mentioned disadvantages. This and other objectives are achieved, at least in part, by providing a computer network in which data traffic passing through transit nodes of the network is directed to a centralised virus scanning server.

According to first aspect of the present invention there is provided a method of detecting viruses in a computer network, the method comprising:

intercepting data at at least one data transit node of the network;

identifying at the transit node which of the data is of a type capable of containing a virus;

transferring the identified data to a virus scanning server over the network; and

receiving the identified data at the virus scanning server and scanning the data to identify viruses present therein.

By centralising the virus scanning process at a virus scanning server, the need to provide virus scanning functionality at each individual transit node is avoided. Rather, only a relatively simple interception and identification functionality needs to be implemented at each of the transit nodes.

The transit node may be a gateway coupling the network to an external system or network, e.g. the Internet. Alternatively, the transit node may be an internal node of the network.

Preferably, the transit node is one of a database server, an electronic mail server, an Internet server, a proxy server, and a firewall.

Preferably, the method of the present invention comprises performing said steps of intercepting, identifying, and transferring at each of a plurality of transit nodes, the transferred data being received by a common virus scanning server. More preferably, the transit nodes comprise respective discrete computer systems, e.g. PCs or workstations. Alternatively however, a plurality of transit nodes may be implemented on the same computer system.

Preferably, the method of the present invention comprises returning the transferred data to the originating transit node from the virus scanning server in the event that no viruses are identified therein. In the event that a virus is identified in the data, the virus scanning server may:

issue a virus alert message to the network administrator and/or to the intended destination for the data either directly or via the originating transit node; and/or

store the infected data in an associated memory; and/or

attempt to disinfect the infected data in which case if the disinfection is successful the disinfected data is returned to the originating transit node and, if unsuccessful, the data is disregarded or stored in the associated memory.

In certain embodiments of the invention, data intercepted at a transit node is stored in a memory of that node, whilst a copy of the data is transferred to the virus scanning server for virus scanning. Assuming the virus scan identifies no viruses in the data, the server need only return an OK (i.e. virus free) message to the transit node.

In certain embodiments of the invention, the network may be provided with only a single virus scanning server which serves one or more transit nodes. In other embodiments however, the network may comprise a plurality of servers. Any given agent may send data to two or more servers depending upon server availability, network traffic etc. This may be particularly useful in the case, for example, of a network firewall having a large volume of through traffic which must be scanned for viruses.

According to a second aspect of the present invention there is provided apparatus for detecting viruses in a computer network, the apparatus comprising:

at least one first computer providing a transit node for data being transferred within the network or destined for the network, the computer having means for intercepting said data and for identifying data which is of a type capable of containing a virus; and

at least one second computer coupled to said network and having processing means for scanning data for viruses,

the first computer additionally having means for transferring any identified data to the second computer over said network for virus scanning.

Preferably, the apparatus of the present invention comprises a plurality of said first computers coupled to said data network and at least one second computer for scanning data for viruses. Alternatively however, a plurality of second computers may be provided.

According to a third aspect of the present invention there is provided a computer memory encoded with executable instructions representing a computer program for causing a computer connected to a data network to:

receive data over the data network from a transit node, said data having been intercepted by the transit node and identified thereat as being of a type capable of containing a virus; and

scan the received data to identify viruses present therein.

### BRIEF DESCRIPTION OF THE DRAWINGS

FIG. 1 shows schematically a data network having a central virus scanning server; and

FIG. 2 is a flow diagram illustrating a virus scanning operation of the network of FIG. 1.

### DETAILED DESCRIPTION OF CERTAIN EMBODIMENTS

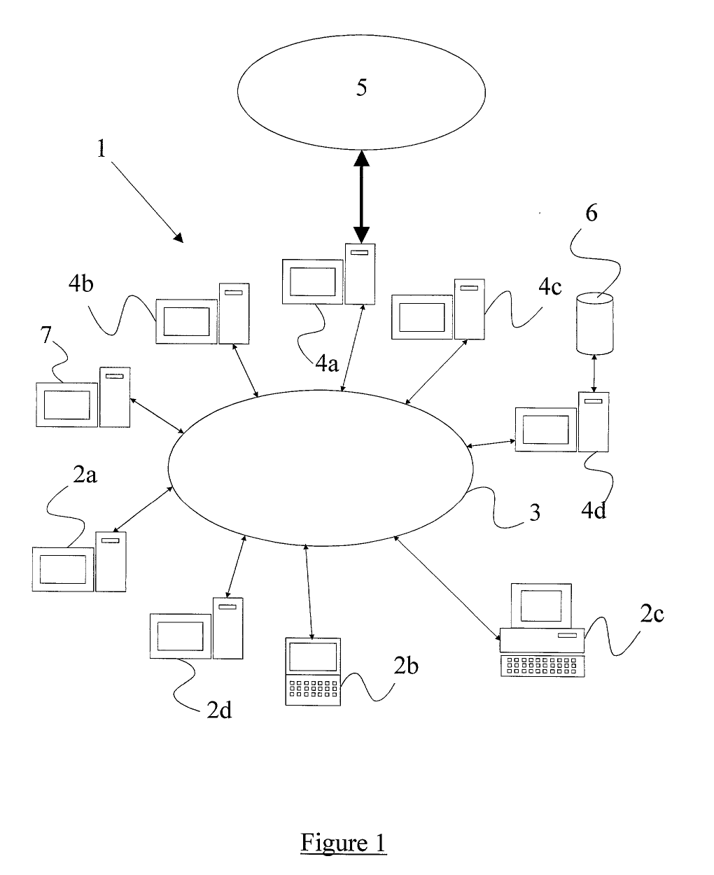

A computer data network (illustrated generally by reference numeral 1) is shown in FIG. 1 and comprises a number of users or clients 2. These users 2 include an administrator's workstation 2a, one or more notebook computers 2b, a number of computer workstations 2c, and a server 2d. The network comprises a physical wire network 3 to which each of the users 2 is connected via respective network cards (generally integrated into the user terminals and therefore not shown separately in FIG. 1). The network may be an Ethernet network, X.25 network, or the like, with TCP/IP protocol being used as the transport protocol. Although it is not considered here in detail, the wire network 3 of FIG. 1 may be replaced by a wireless network, e.g. using radio signals to transmit data.

Also connected to the network (via respective network cards) are a number of so-called “protected systems” 4. These include a firewall 4a, a mail server 4b, a proxy server 4c, and a database server 4d. As will be known to the skilled person, the firewall 4a provides a secure gateway between the network 1 and the “outside world”, in this case the Internet 5. All data traffic coming from the Internet 5 to the network 1 passes through the firewall 4a where its access authority is checked. The firewall 4a may also control the access of users 2 to the Internet 5. The mail server 4b and the proxy server 4c provide transit nodes for electronic mail and WWW traffic respectively. Data is routed between the mail server 4b and the proxy server 4c, and the Internet 5, via the firewall 4a. The mail server 4b may also act as a router for internal network electronic mail.

The protected systems 4 also include a database server 4d which acts as a gateway or transit node between the network 1 and a central data storage facility 6. This facility is a repository for data shared by the network users 2.

An additional server 7 provides virus scanning functionality as will be described below. This virus scanning server 7 is coupled to the network 1 and in use communicates with the protected systems 4 and the administrator's work station 2a. The server 7 is able to communicate with the protected systems 4 and workstation 2a using for example proprietary and standardised protocols carried over the TCP/IP network 3.

Each of the protected systems 4 has stored in its memory a so-called “agent” program which is run by the system, in the background to the normal tasks performed by the systems. The agent's function is to intercept data which is being transferred through the system 4 on which the agent is running. The intercepted data is scanned on-the-fly by the agent to determine whether or not the data has a form which may contain a virus. Thus, the agent may identify data files having the .doc,.dot, .exe, etc, extensions. Considering for example the firewall 4a, this will intercept and scan data being transferred from the Internet 5 to the network 3, and possibly data traveling in the opposite direction. Similarly, the mail server 4b and proxy server 4c will intercept and scan mail and WWW data respectively, whilst the database server 4d scans data being transferred to and from the data storage facility 6. Of course the network may be arranged such that the unnecessary duplication of tasks is avoided, e.g. the mail server 4b does not scan data received from the firewall 4a but only scans internally transferred mail.

Data which is not of a suspect type is passed over by the agent and is routed by the system to its intended user 2. However, any data which is identified by the agent as being suspect, is re-routed over the network 1, from the protected system in question, to the virus scanning server 7. Upon receipt of the suspect data, the server 7 scans the data for viruses. This scanning may be performed by one of a number of known scanning systems including F-PROT TM and F-SECURE TM available from DataFellows (Helsinki, Finland).

Typically, if the scanning operation performed by the server 7 fails to identify any viruses in the received data, the data is returned to the originating system 4 over the network 1. The system 4 then routes the data over the network 1 to its originally intended destination, i.e. one of the users 2. In the event that a virus is identified by the virus scanning server 7, the server may take one of a number of different courses of actions.

Firstly, if the virus is one which can be removed from the data by the server 7, then this disinfection operation is performed. The repaired data is returned to the originating system 4 together with an attached notice that the original data contained a virus and has been repaired. The repaired data and attached message are then forwarded to the original destination, i.e. user 2. If the virus is one which cannot be removed from the data, the data is placed in a “quarantine” memory associated with the server 7. A message is sent to the destined user 2, e.g. via an electronic mail message, advising that the data contains a virus and has been quarantined. In both cases, i.e. where the data is repairable or unrepairable, the server 7 sends an advice message to the administrator's workstation 2a.

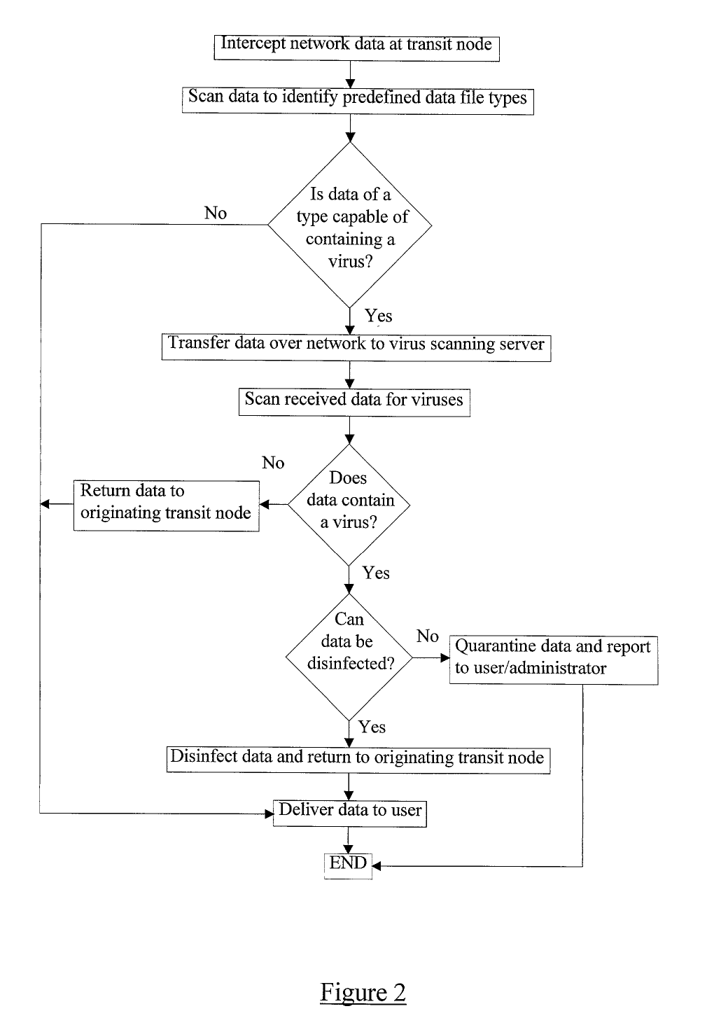

There is shown in FIG. 2a flow diagram which further illustrates the virus detection procedure described above.

It will be appreciated by the person of skill in the art that various modifications may be made to the above described embodiment without departing from the scope of the present invention. For example, suspect data rerouted to the virus scanning server 7 may be transmitted to the destined user 2 (assuming that the data is uninfected or repaired) directly over the network 3 rather than via the originating system 4. It will also be appreciated that the invention may be employed in the network described using suitable software stored at the transit nodes 4 and at the virus scanning server 7, or using a combination of hardware and software.

The systems 4 protected against viruses, by incorporating thereinto an appropriate agent, have been described above as comprising discrete computers. However, these systems may alternatively be viewed as software systems. Thus, for example, a proxy server and a mail server may be implemented on the same computer, each having an associated agent or sharing a common agent. Similarly, the virus scanning server 7 may run on a computer which also runs, for example, a firewall application or another server application.

More generally, it will be appreciated that the present invention provides great flexibility in network design. Agents may be placed at all important data transit nodes, e.g. firewalls, servers, etc, with only a single central virus scanning server of course, in a large network, several virus scanning servers may be employed, each catering for a cluster of dispersed agents.

Whilst the embodiment described in detail above included only a single virus scanning server 7, for networks having a large volume of data traffic requiring virus scanning, a plurality of such servers 7 may be provided. Indeed, a single protected server 4 may direct different data files to different virus scanning servers 7 depending upon the volume of data passing through the protected server 4 and the availability of the virus scanning servers 7.

1. A method of detecting viruses in a computer network, the method comprising:
intercepting data at at least one data transit node of the network;
identifying at the transit node which of the data is of a type capable of containing a virus;
transferring the identified data to a virus scanning server over the network; and
receiving the identified data at the virus scanning server and scanning the data to identify viruses present therein.

2. A method according to claim 1, wherein the transit node is a gateway coupling the network to an external system or network.

3. A method according to claim 1, wherein the transit node is one of a database server, an electronic mail server, an Internet server, a proxy server, and a firewall.

4. A method according to claim 1 and comprising performing said steps of intercepting, identifying, and transferring at each of a plurality of transit nodes, the transferred data being received by at least one common virus scanning server.

5. A method according to claim 4, wherein each transit node comprises a discrete computer system.

6. A method according to claim 1 and comprising returning the transferred data to the originating transit node from the virus scanning server in the event that no viruses are identified therein.

7. A method according to claim 1 and comprising returning a message to the originating transit node from the virus scanning server to indicate the result of the virus scan.

8. A method according to claim 1, wherein, in the event that a virus is identified in the data, the virus scanning server:
issues a virus alert message to the network administrator and/or to the intended destination for the data either directly or via the originating transit node; and/or
stores the infected data in an associated memory; and/or
attempts to disinfect the infected data in which case, if the disinfection is successful, the disinfected data is returned to the originating transit node and, if unsuccessful, the data is disregarded or stored in the associated memory.

9. A method according to claim 1, wherein the virus scanning server is one of a plurality of virus scanning servers of the computer network.

10. Apparatus for detecting viruses in a computer network, the apparatus comprising:
a first computer providing a transit node for data being transferred within the network or destined for the network, the computer having means for intercepting said data and for identifying data which is of a type capable of containing a virus; and
a second computer coupled to said network and having processing means for scanning data for viruses,
the first computer additionally having means for transferring any identified data to the second computer over said network for virus scanning.

11. Apparatus according to claim 10 and comprising a plurality of said first computers coupled to said data network and one second computer for scanning data for viruses.

12. A computer memory encoded with executable instructions representing a computer program for causing a computer connected to a data network to:
receive data over the data network from a transit node, said data having been intercepted by the transit node and identified thereat as being of a type capable of containing a virus; and
scan the received data to identify viruses present therein.
